(19) United States
(12) Patent Application Publication
(10) Pub. No.: US 2023/0050692 A1
(43) Pub. Date: Feb. 16, 2023

(54) Directivity Backlight Display Device with Reflector Curvature Assisted Diffuser

(71) Applicant: E-LEAD ELECTRONIC CO., LTD., Changhua (TW)

(72) Inventor: Stephen CHEN, Changhua (TW)

(21) Appl. No.: 17/524,098

(22) Filed: Nov. 11, 2021

(30) Foreign Application Priority Data
Aug. 12, 2021 (TW) 110129782

(51) Int. Cl. F21V 7/00; F21V 7/04; G02B 27/01; G02B 17/08

(52) U.S. Cl. CPC F21V 7/0008; F21V 7/04; G02B 27/0101; G02B 17/0816

(57) ABSTRACT

A directivity backlight display device with reflector curvature assisted diffuser includes a light source module, a reflective narrow-angle diffuser, a concave reflector, and a backlit type display panel. The light source module projects a light. The reflective narrow-angle diffuser includes a concave surface or a flat surface served as a reflecting surface. The reflecting surface is provided with a plurality of micro curved mirrors laid out in an array. The light is reflected and diffused by the reflective narrow-angle diffuser and the concave reflector to provide a uniform directional light beam. A backlit type display panel is deployed to display an image. The uniform directional light beam penetrates the backlit type display panel to provide a directional image light beam, and then projects the directional image light beam to a projection area. With this arrangement, a reflective narrow-angle diffuser with a low concave curvature is deployed to achieve a high-directivity image projection.

### BACKGROUND

### Technical Field

The present disclosure is directed to a directivity backlight display device with reflector curvature assisted diffuser deploying a reflective narrow-angle diffuser with a low curvature or a flat surface, assisted with a concave reflector with a high curvature to compensate the lack of the concave curvature to achieve a high-directivity image projection, alleviating difficulty producing diffusers, raising yield, and reducing cost.

### Related Art

Please refer to FIG. 1, US20180252915A1 discloses that the image projected by the projector 41 is reflected and diffused into the eyes box of an observer with a narrow angle by using a reflective narrow-angle diffuser 2 to improve the utilization of light and increase observed image brightness. After the light of each pixel of the image is reflected and diffused by the reflective narrow-angle diffuser, it can be evenly diffused to the eye box of the observer. The aforementioned projector 41 is an LCD projector, a DLP projector, or a Laser projector.

Please refer to FIG. 2, the reflective narrow-angle diffuser 2 can be flat or curved, and the reflective narrow-angle diffuser 2 has an array composed of a plurality of micro curved mirrors 200 laid out in a square arrangement or hexagonal honeycomb arrangement (i.e., a reflective narrow-angle diffuser 20 in FIG. 7A). Each micro curved mirror 200 sizes in a range of 2.5 μm˜0.25 mm. Each of the plurality of micro curved mirrors 200 is provided with identical or non-identical curvatures and angles. The quantity of the micro curved mirrors 200 can be customized according to the resolution and optical path design requirements.

Please refer to FIG. 3A, a flat-surfaced reflector is characterized with a smooth and flat surface, an angle of incidence of an incident light equals to an angle of reflection of a reflected light, so the spread angle of the beam remains unchanged, there is no diffusion effect, and the viewing angles is limited.

Please refer to FIG. 3B, a projection screen is a flat surface. In order to allow observers from all angles to see the projected image, a wide scattering surface is required to diffuse the light projected on the plane in all directions (i.e., a diffusion angle is θ1), but at the same time, the brightness of the image observed by the observers is greatly reduced.

Please refer to FIG. 3C, the micro curved mirrors of the reflective narrow-angle diffuser can diffuse incident light toward a preset direction with preset and narrow diffusion angle θ2, so it can significantly increase the brightness of observing images within the range of the preset direction and the diffusion angle θ2. Among them, the reflective surface of the micro curved mirror can be concave or convex.

Please refer to FIG. 4A, a light source 11 after condensation becomes the directional light beam prone to uneven brightness, e.g., the brightness in the center is high; the brightness on the periphery is low. To improve this problem, the light source 11 can project light to a reflective narrow-angle diffuser as shown in FIG. 4B, and the light reflected by the micro curved mirror array can diffuse toward a preset direction with a narrow diffusion angle, providing a directional light beam with uniform brightness.

Please refer to FIG. 5A and FIG. 5B, the reflective narrow-angle diffuser is a dual-curved concave surface, that is, both of an X-axis cross-section of concave surface and a Y-axis cross-section of concave surface are shown as curves.

According to curvatures of the concave surface, the concave surface is divided into a flat surface without any curvature as shown in FIG. 6D, a slightly concave surface with a low curvature as show in FIG. 6B and FIG. 6C, and a concave surface with a high curvature as shown in FIG. 6A.

The aforementioned reflective narrow-angle diffuser can be manufactured using rigid materials (such as metallic materials, ceramic materials or hard polymer materials) in a mold forming manner, but the production cost is relatively high.

Please refer to FIG. 7A, another method is illustrated to produce the diffuser, elastic materials (such as rubber, elastic polymer materials) being deployed to produce a flat structure provided with an array of micro curved mirrors 200, coated with a reflective film to form a flat reflective narrow-angle diffuser 20. A dual-curved concave substrate S1 is produced with rigid materials, and then, the elastic flat reflective narrow-angle diffuser 20 and the dual-curved concave substrate S1 are attached in a bonding process to form a dual-curved concave reflective narrow-angle diffuser 21.

Because the space between the flat reflective narrow-angle diffuser 20 and the dual-curved concave substrate S1 contains air before bonding, even if a plurality of air vents are disposed on the substrate, air bubbles are likely to remain during the bonding process, which affects flatness of the reflective surface, and the deformation of each micro-mirror is also more difficult to control, which affects the quality of the optical image and also reduces the production yield. The greater the curvature of the concave surface of the substrate S1, the more difficult the production process, the more serious the problem; although the bonding process can be performed in a high-vacuum environment, the flat reflective narrow-angle diffuser 20 is pre-fixed on the convex jig T1, as shown in FIG. 8A, to solve the problem of residual bubbles, but the process and equipment are expensive.

### SUMMARY

The present disclosure is directed to a directivity backlight display device with reflector curvature assisted diffuser comprises the following.

A light source module projects a light.

A reflective narrow-angle diffuser comprises a reflecting surface. The reflecting surface is provided with a plurality of micro curved mirrors laid out in an array.

A concave reflector comprises a concave surface served as a reflecting surface, the concave surface compensates for the lack of concave curvature of the reflective narrow-angle diffuser, so the light is reflected by the reflective narrow-angle diffuser and the concave reflector and is diffused by the reflective narrow-angle diffuser to provide a uniform directional light beam.

A backlit type display panel displays an image. The uniform directional light beam penetrates the backlit type display panel and becomes a directional image light beam, which is projected to a projection area (i.e., an eye box of an observer).

In view of the shortcomings of the conventional arts, the present disclosure provides a reflective narrow-angle diffuser with a low curvature and a concave reflector with a high curvature to replace the dual-curved concave reflective narrow-angle diffuser to provide a uniform directional light beam, which alleviates the difficulty of making the diffuser, raises the production yield, reduces the cost.

Please refer to FIG. 4C, the aforementioned uniform directional light beam is served as a backlight of the backlit type display panel, and is used to illuminate the image displayed on the backlit display panel (e.g., an LCD panel), and project the image to a preset eye box of an observer, so that, the light passing through each pixel of the image diffuses uniformly to any position of the eye box of the observer.

In some embodiments, the reflective narrow-angle diffuser has two axes perpendicular to each other. The reflecting surface of the reflective narrow-angle diffuser extends along the two axes to form a dual-curved slightly concave surface with a low curvature. The concave reflector has two axes perpendicular to each other. The reflecting surface of the concave reflector extends along the two axes to form a dual-curved concave surface. The two axes of the concave reflector correspond to the two axes of the reflective narrow-angle diffuser. In some embodiments, curvatures along the two axes of the slightly concave surface of the reflective narrow-angle diffuser are smaller than curvatures along the two axes of the concave surface of the concave reflector, or the curvature along one of the two axes of the slightly concave surface of the reflective narrow-angle diffuser is smaller than the curvature along the corresponding axis of the concave surface of the concave reflector, the curvature along the other axis of the slightly concave surface of the reflective narrow-angle diffuser being greater than the curvature along the corresponding axis of the concave surface of the concave reflector.

In some embodiments, the reflective narrow-angle diffuser comprises the reflecting surface extending along one axis to form a single-curved concave surface. The concave reflector comprises the reflecting surface extending along the other axis to form a single-curved concave surface. In some embodiments, the axis of the concave reflector is perpendicular to the axis of the reflective narrow-angle diffuser. In some embodiments, axes of the concave surface of the reflective narrow-angle diffuser corresponds to the vertical direction, the horizontal direction, the 45-degree oblique direction or any directions of the displayed image.

In some embodiments, the reflective narrow-angle diffuser comprises the reflecting surface extending along one axis to form a single-curved slightly concave surface with a low curvature. The concave reflector has two axes perpendicular to each other. The reflecting surface of the concave reflector extends along the two axes to form a dual-curved concave surface. One of the two axes of the concave reflector is parallel to the axis of the reflective narrow-angle diffuser. In some embodiments, axes of the concave surface of the reflective narrow-angle diffuser correspond to the vertical direction, the horizontal direction, the 45-degree oblique direction or any directions of the displayed image.

In some embodiments, the concave reflector is positioned on an optical path between the light source module and the reflective narrow-angle diffuser, so the concave reflector and the reflective narrow-angle diffuser sequentially perform the first and second light convergence, or the concave reflector is positioned on an optical path between the reflective narrow-angle diffuser and the backlit type display panel, so the reflective narrow-angle diffuser and the concave reflector sequentially perform the first and second light convergence.

In some embodiments, the reflective narrow-angle diffuser comprises a flat surface served as a reflecting surface. The concave reflector has two axes perpendicular to each other. The reflecting surface of the concave reflector extends along the two axes to form a dual-curved concave surface, so the light is converged by the concave reflector, and then reflected and diffused by the reflective narrow-angle diffuser with a narrow diffusion angle. The two axes of the concave reflector correspond to the vertical direction and the horizontal direction of the displayed image respectively. Curvatures along the two axes of the concave surface of the concave reflector are identical or non-identical.

In the above-mentioned embodiment, the concave reflector is placed on the light path between the light source module and the reflective narrow-angle diffuser; or, the concave reflector is placed on the light path between the reflective narrow-angle diffuser and the backlit display panel.

In some embodiments, a windshield is included in front of the directivity backlight display device, the image light projecting to the windshield, the windshield reflecting part of the image light to the projection area.

In some embodiments, a concave mirror is included in the directivity backlight display device. The image is magnified by the concave mirror before being projected onto the windshield, and the windshield reflects part of the image light to the projection area.

### BRIEF DESCRIPTION OF THE DRAWINGS

FIG. 1 is a schematic diagram of a conventional art of the applicant;

FIG. 2 is a schematic diagram of a reflective narrow-angle diffuser;

FIG. 3A, FIG. 3B, and FIG. 3C are schematic diagrams illustrating the projected light being diffused at various reflecting surfaces;

FIG. 4A, FIG. 4B, and FIG. 4C are schematic diagrams illustrating the reflective narrow-angle diffuser being deployed to generate a uniform directional backlight;

FIG. 5A and FIG. 5B are schematic diagrams of a dual-curved concave reflective narrow-angle diffuser;

FIG. 6A, FIG. 6B, FIG. 6C, and FIG. 6D are schematic diagrams of the reflective narrow-angle diffuser with various curvatures;

FIG. 7A, FIG. 7B, and FIG. 7C are schematic diagrams of bonding reflective narrow-angle diffusers;

FIG. 8A, FIG. 8B, and FIG. 8C are schematic diagrams of bonding process of the reflective narrow-angle diffusers;

FIG. 9A and FIG. 9B are schematic diagrams illustrating the difference in projection between a dual-curved concave reflective narrow-angle diffuser and a dual-curved slightly concave reflective narrow-angle diffuser;

FIG. 10A, FIG. 10B, and FIG. 10C are schematic diagrams of a concave reflector being deployed to assist the projection of the reflective narrow-angle diffuser;

FIG. 11A and FIG. 11B are schematic diagrams according to some embodiment of the present disclosure;

FIG. 12A, FIG. 12B, and FIG. 12C are schematic diagrams illustrating the difference in projection between the dual-curved concave reflective narrow-angle diffuser and a single-curved concave reflective narrow-angle diffuser;

FIG. 13A is a schematic diagram of a single-curved concave reflector being deployed to assist the single-curved concave reflective narrow-angle diffuser;

FIG. 13B, FIG. 13C, FIG. 14A and FIG. 14B are schematic diagrams according to some embodiment of the present disclosure;

FIG. 15A, FIG. 15B, FIG. 16A, and FIG. 16B are schematic diagrams according to some embodiment of the present disclosure;

FIG. 17 is a schematic diagram illustrating the projection of a flat-surfaced reflective narrow-angle diffuser;

FIG. 18A and FIG. 18B are schematic diagrams of a dual-curved concave reflector being deployed to assist the projection of the flat-surfaced reflective narrow-angle diffuser;

FIG. 19A and FIG. 19B are schematic diagrams according to some embodiment of the present disclosure;

FIG. 20 is a schematic diagram illustrating an embodiment in an automobile;

FIG. 21 is a schematic diagram of another embodiment in an automobile.

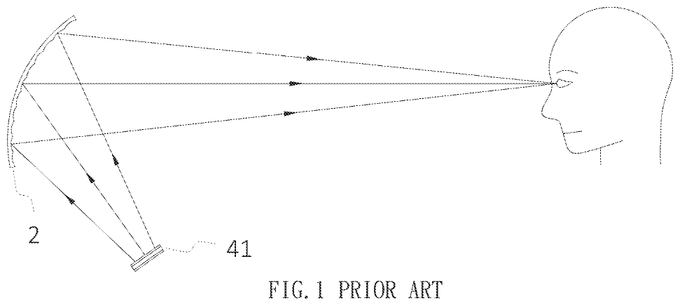

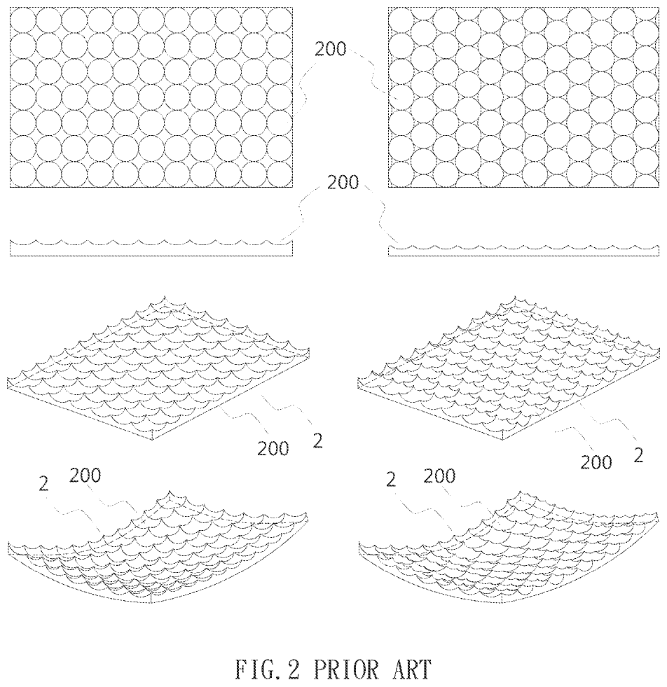

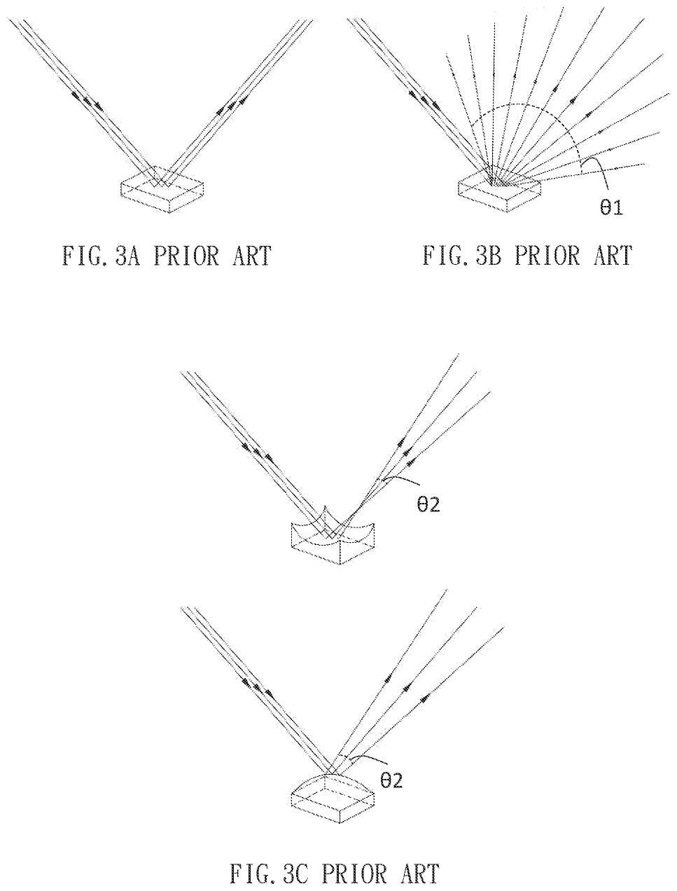

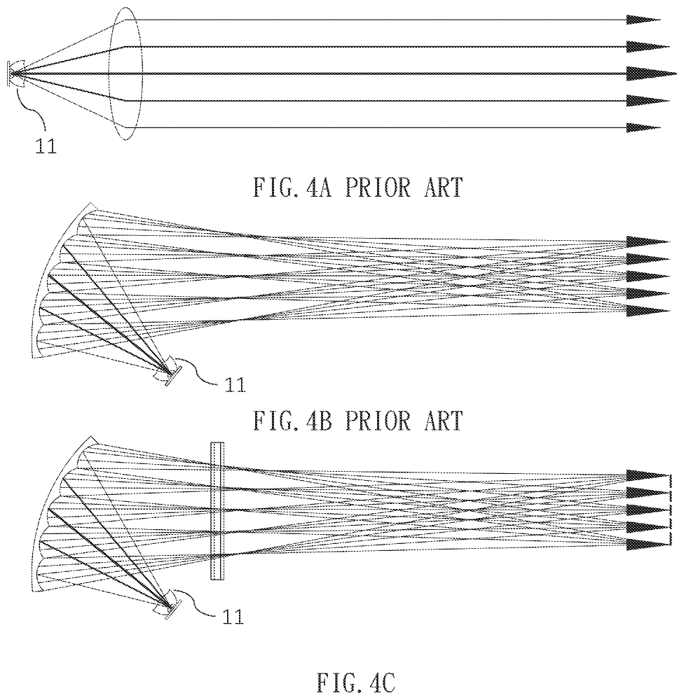

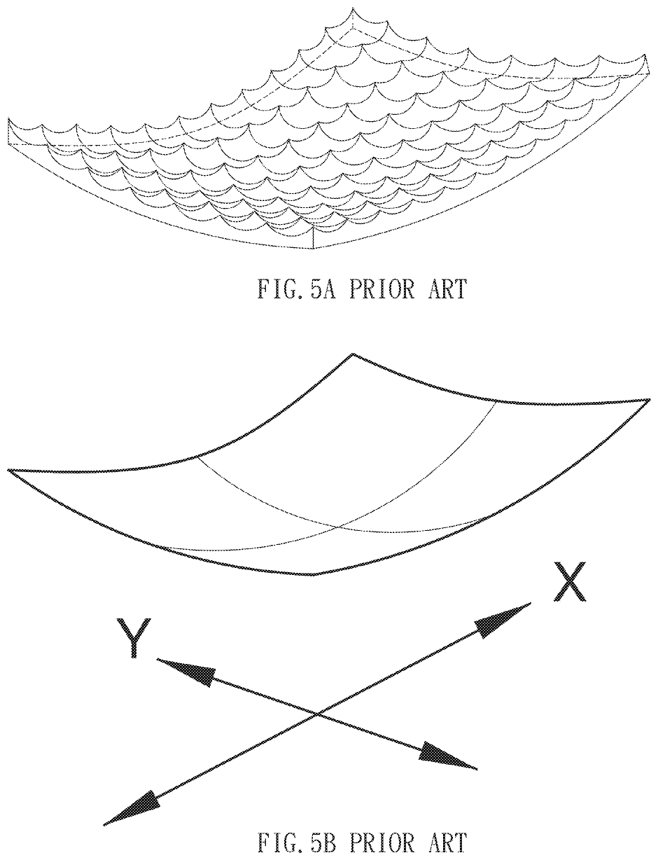

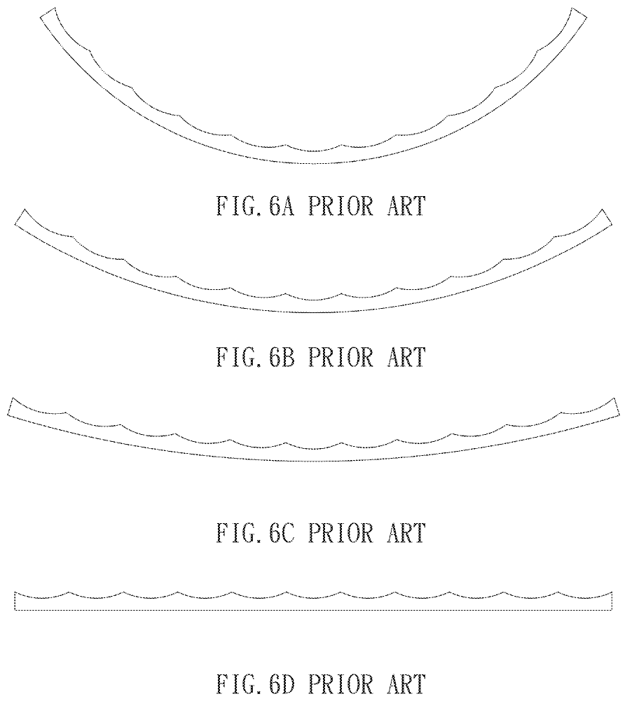

### DETAILED DESCRIPTION

The term “slightly concave surface” or “concave surface” herein, compared to a concave surface of a conventional reflective narrow-angle diffuser, has a smaller effect of light converging. In some embodiments, curvatures of the concave surface are greater than curvatures of the slightly concave surface. In some embodiments, curvatures of the concave surface and curvatures of the slightly concave surface are identical.

The term “compensate” or “assist” herein refers to when the light is reflected by the reflective narrow-angle diffuser and the concave reflector, the concave reflector is included to assist and compensate for the lack of convergence of the light during the reflection of the light performed by the reflective narrow-angle diffuser (micro curved mirrors), so enables all the rays of light to converge to the same projection area after penetrating the backlit type display panel, which is sufficient to cover the preset projection area.

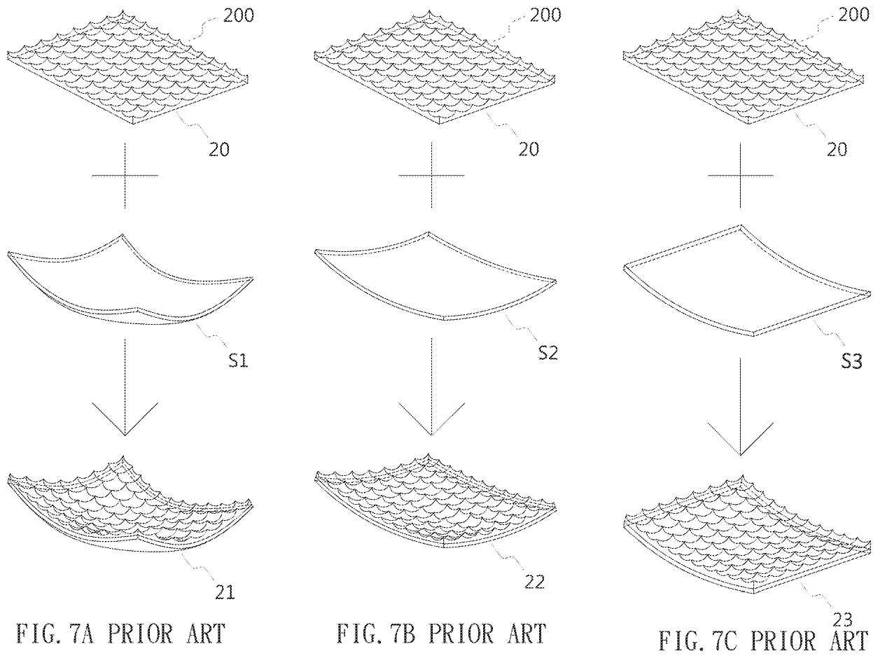

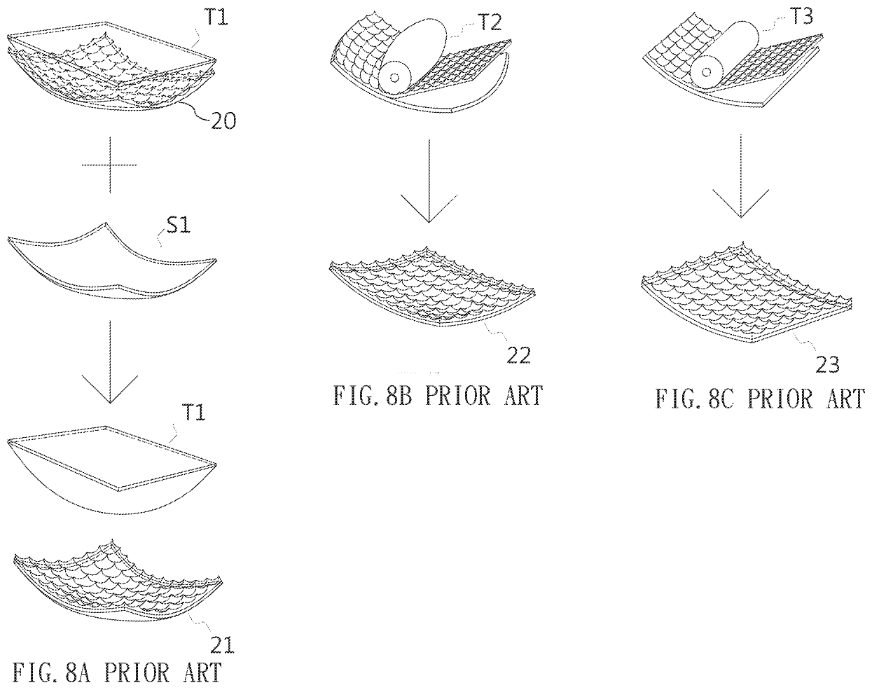

Compared to a difficulty of producing a dual-curved concave reflective narrow-angle diffuser, the difficulty is alleviated by reducing the curvature of the concave surface of the reflective narrow angle diffuser. Please refer to FIG. 7B, bonding a flat-surfaced reflective narrow-angle diffuser 20 to a dual-curved slightly concave substrate S2, a dual-curved slightly concave reflective narrow-angle diffuser is made, hereby greatly improving a production yield. Please refer to FIG. 8B, a spindle-shaped fitting roller T2 is deployed to bond the diffuser, hereby ensuring a close fit without air bubbles.

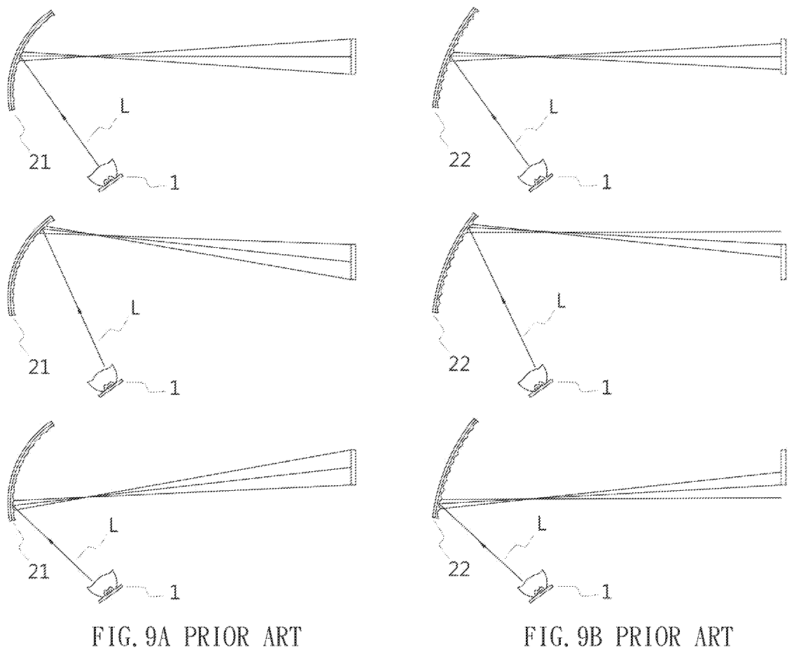

Please refer to FIG. 9A, the dual-curved concave reflective narrow-angle diffuser 21 reflects and diffuses a light L to a preset projection area. Please refer to FIG. 9B, the dual-curved slightly concave reflective narrow-angle diffuser 22 replaces the dual-curved concave reflective narrow angle diffuser 21. Due to the reduced curvature also reduces the curvature of the micro-concave mirror, the reflected and diffused light L is unable to cover the preset projection area, the light at various positions of the diffuser being unable to be projected to the same area.

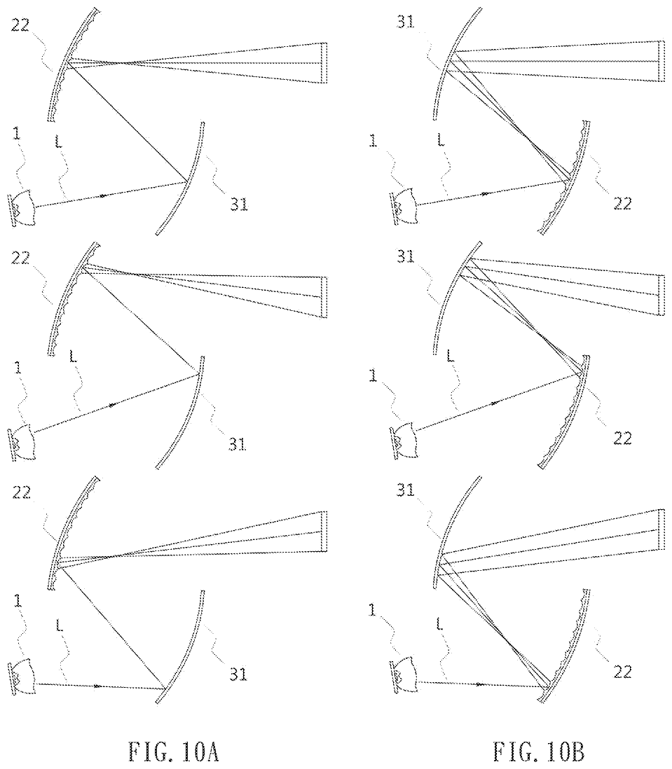

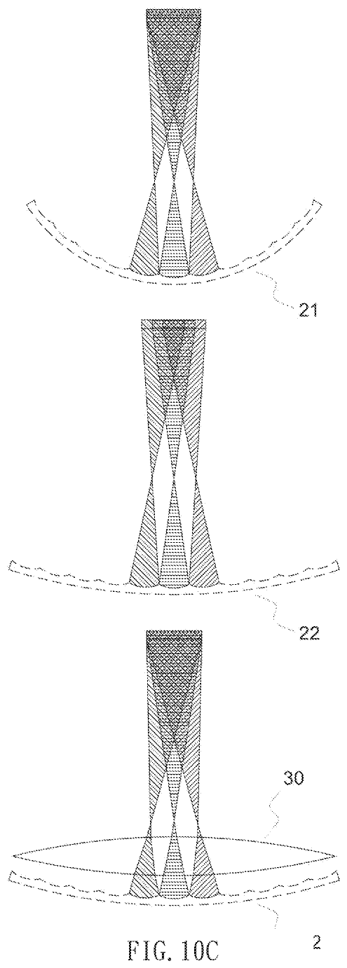

In order to converge the reflected and diffused light L, in some embodiments as shown in FIG. 10A, a concave reflector 31 is positioned between a light source 1 and the reflective narrow-angle diffuser 22, or in some embodiments as shown in FIG. 10B, the concave reflector 31 is included behind the reflective narrow-angle diffuser 22 to compensate for the insufficient axial concave curvature of the reflective narrow-angle diffuser 22, hereby the projected light being converged to the same area and is sufficient to cover the preset projection area. Please refer to FIG. 10C, a concave reflector 31 is deployed, it is similar to adding a convex lens 30 on an optical path to change the projected light path and diffusion area of each micro-mirror, so the light at various positions on the diffuser is projected and diffused to the same projection area.

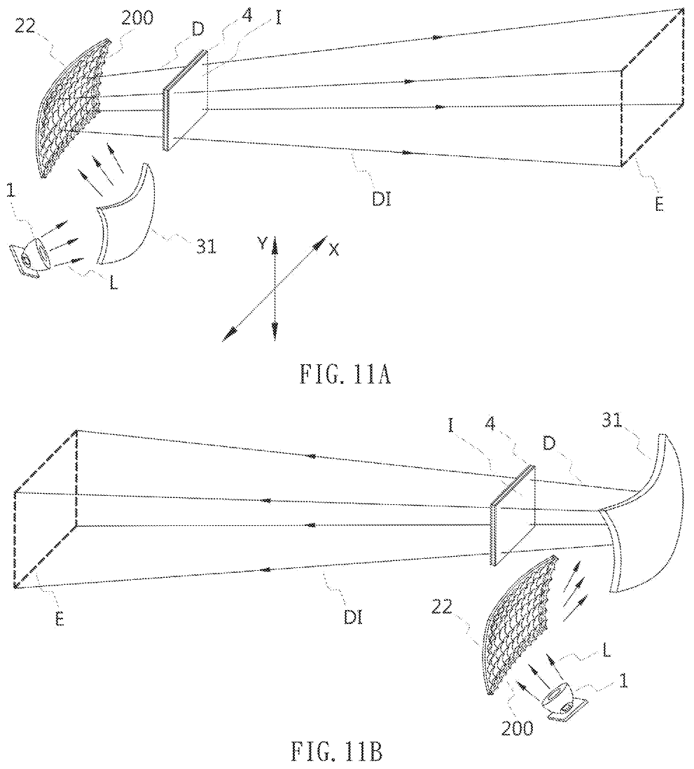

Please refer to FIG. 11A and FIG. 11B, the present disclosure provides an embodiment of a directivity backlight display device with reflector curvature assisted diffuser comprising a light source module 1 projecting a light L, a reflective narrow-angle diffuser 22, a concave reflector 31 and a backlit type display panel 4.

The reflective narrow-angle diffuser 22 has two axes cross each other perpendicularly. The reflective narrow-angle diffuser 22 extends along the two axes to form a dual-curved concave surface with a low curvature (i.e., a dual-curved slightly concave surface) served as a reflecting surface. The reflecting surface is provided with a plurality of micro curved mirrors 200 laid out in an array to reflect and diffuse the light L.

A concave reflector 31 has two axes cross each other perpendicularly. The concave reflector 31 extends along the two axes to form a dual-curved concave surface. The two axes of the concave surface of the concave reflector 31 correspond to the two axes of the reflective narrow-angle diffuser 22. The concave reflector 31 compensates for the insufficient curvature of the concave surface of the reflective narrow-angle diffuser 22, so the light L is reflected and diffused by the reflective narrow-angle diffuser 22 and the concave reflector 31 to provide a uniform directional light beam D.

A backlit type display panel 4 displays an image I, the uniform directional light beam D penetrates the backlit type display panel 4 and then becomes a directional image light beam DI, and the directional image light beam DI projects to a projection area (i.e., an eye box E of an observer).

Please refer to FIG. 11A, the concave reflector 31 is positioned on an optical path between the light source module 1 and the reflective narrow-angle diffuser 22. The concave reflector 31 deploys the dual-curved concave surface to converge the light L for the first time and reflect the light L to the reflective narrow-angle diffuser 22, the reflective narrow-angle diffuser 22 deploying the dual-curved slightly concave surface to converge the light L for the second time and diffuse each point of light L with a narrow diffusion angle, so that the reflected and diffused uniform directional light beam D penetrating the backlit type display panel 4, and then projecting to the eye box E in high directivity.

Please refer to FIG. 11B, the concave reflector 31 is positioned on an optical path between the reflective narrow-angle diffuser 22 and the backlit type display panel 4. The reflective narrow-angle diffuser 22 deploys the dual-curved slightly concave surface to converge the light L for the first time and diffuse each point of light L with a narrow diffusion angle, and reflect the light L to the concave reflector 31, the concave reflector 31 deploying the dual-curved concave surface to converge the light L for the second time, so that the reflected and diffused uniform directional light beam D penetrating the backlit type display panel 4, and then projecting to the eye box E in high directivity.

In some embodiments, curvatures along the two axes of the slightly concave surface of the reflective narrow-angle diffuser 22 are smaller than curvatures along the two axes of the concave surface of the concave reflector 31.

In some embodiments, the curvature of the slightly concave surface of the reflective narrow-angle diffuser 22 along one of the two axes (e.g., the X-axis in FIG. 11A) is smaller than the curvature of the concave surface of the concave reflector 31 along the corresponding axis. The curvature of the slightly concave surface of the reflective narrow-angle diffuser 22 along the other axis (e.g., the Y-axis in FIG. 11A) is greater than the curvature of the concave surface of the concave reflector 31 along the corresponding axis.

Please refer to FIG. 7C, compared to a difficulty of producing the dual-curved concave reflective narrow-angle diffuser, the difficulty is alleviated by deploying a reflective narrow-angle diffuser extending along one axis forming a single-curved concave surface. Bond a flat-surfaced reflective narrow-angle diffuser 200 to a single-curved concave substrate S3, a single-curved concave reflective narrow-angle diffuser is made, hereby raising a production yield. Please refer to FIG. 8C, a cylindrical fitting roller T3 is deployed to bond the diffuser, hereby ensuring a close fit without air bubbles.

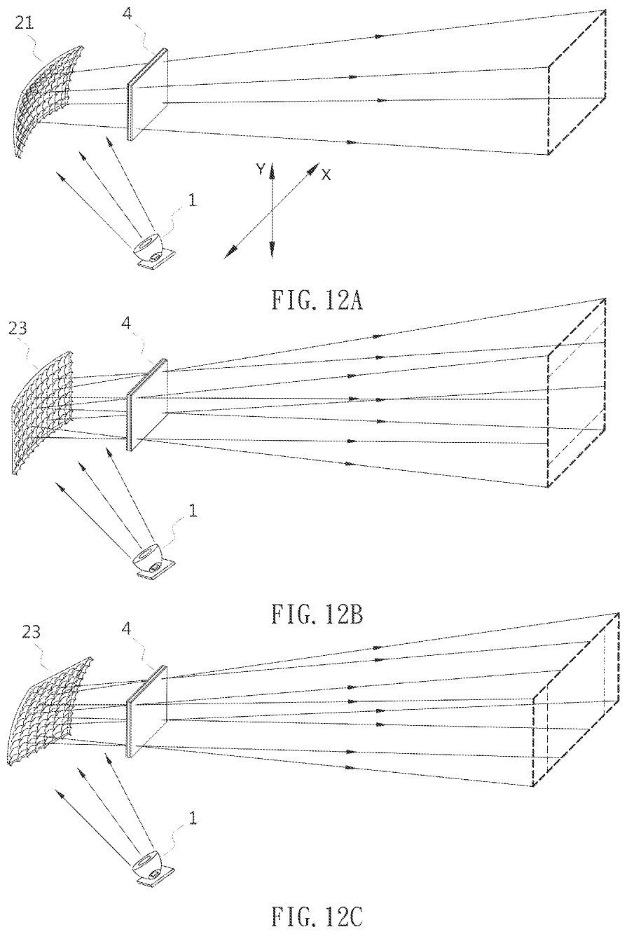

Please refer to FIG. 12A, the dual-curved concave reflective narrow angle diffuser 21 reflects and diffuses a light to a preset projection area. Please refer to FIG. 12B, and FIG. 12C, the single-curved concave reflective narrow-angle diffuser 23 replaces the dual-curved concave reflective narrow angle diffuser 21. The light is reflected and diffused by the single-curved reflective narrow-angle diffuser 23, the reflected and diffused light at different positions of the diffuser unable to be projected to the same area, the reflected and diffused light is distributed beyond the preset projection area in the non-curved axial direction of the reflective narrow-angle diffuser 23. Please refer to FIG. 12B, the Y-axis is served as the non-curved axis of the reflective narrow-angle diffuser 23, the reflected and diffused light is distributed beyond the preset projection area in the Y-axis. Please refer to 12C, X-axis is served as the non-curved axis of the reflective narrow-angle diffuser 23, the reflected and diffused light is distributed beyond the preset projection area in the X-axis.

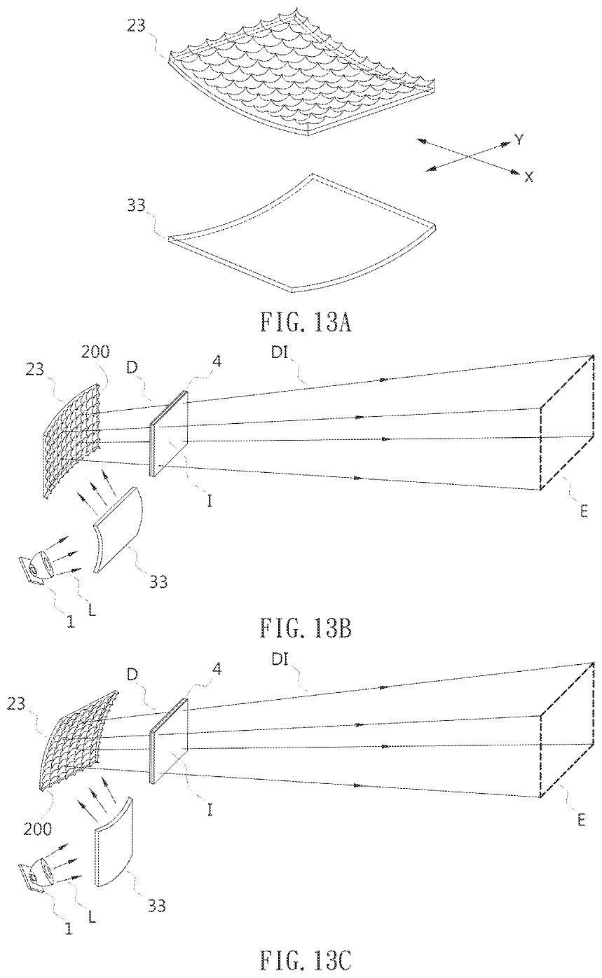

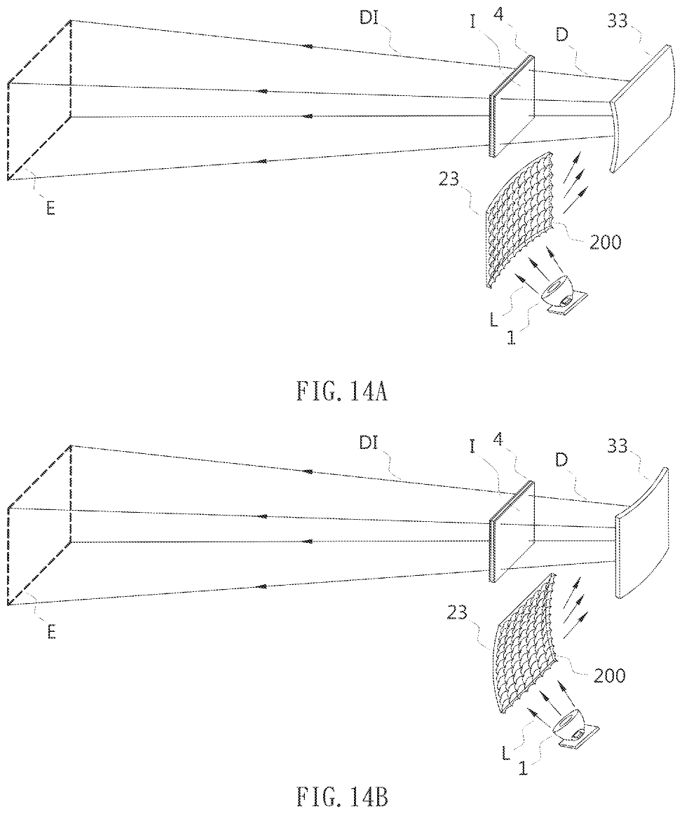

Please refer to FIG. 13A, in order to converge the reflected and diffused light, the single-curved concave reflective narrow-angle diffuser 23 is assisted with a single-curved concave reflector 33 to compensate for the lack of axial direction concave curvature of the reflective narrow-angle diffuser. When the concave surface of the reflective narrow-angle diffuser 23 extends along the X-axis, the concave surface of the single-curved concave reflector 33 extending along the Y-axis. When the concave surface of the reflective narrow-angle diffuser 23 extends along the Y-axis, the concave surface of the single-curved concave reflector 33 extending along the X-axis. The concave surface of the reflective narrow-angle diffuser 23 and the concave surface of the concave reflector 33 are complementary to each other, hereby the projected light rays are all converged to the same area, which is sufficient to cover the preset projection area.

Please refer to FIG. 13B, FIG. 13C, FIG. 14A and FIG. 14B, the present disclosure provides an embodiment of a directivity backlight display device with reflector curvature assisted diffuser comprising a light source module 1 projecting a light L, a reflective narrow-angle diffuser 23, a concave reflector 33, and a backlit type display panel 4.

A reflective narrow-angle diffuser 23 extends along one axis to form a single-curved concave surface served as a reflecting surface. The reflecting surface is provided with a plurality of micro curved mirrors 200 laid out in an array to reflect and diffuse the light L.

A concave reflector 33 extends along one axis to form a single-curved concave surface. The axis of the concave surface is perpendicular to the axis of the concave surface of the reflective narrow-angle diffuser 23. The concave reflector 33 compensates for the lack of axial direction curvature of the concave surface of the reflective narrow-angle diffuser 23, so the light L is reflected and diffused by the reflective narrow-angle diffuser 23 and the concave reflector 33 to provide a uniform directional light beam D.

A backlit type display panel 4 displays an image I, the uniform directional light beam D penetrates the backlit type display panel 4 and then becomes a directional image light beam DI, and the directional image light beam DI projects to a projection area (i.e., an eye box E of an observer).

Please refer to FIG. 13B and FIG. 13C, the concave reflector 33 is positioned on an optical path between the light source module 1 and the reflective narrow-angle diffuser 23. The concave reflector 33 deploys the single-curved concave surface to converge the light L for the first time and reflect the light L to the reflective narrow-angle diffuser 23, the reflective narrow-angle diffuser 23 deploying the single-curved concave surface at different axes to converge the light L for the second time and diffuse each point of light L with a narrow diffusion angle, so that the reflected and diffused uniform directional light beam D penetrating the backlit type display panel 4, and then projecting to the eye box E in high directivity.

Please refer to FIG. 14A and FIG. 14B, the concave reflector 33 is positioned on an optical path between the reflective narrow-angle diffuser 23 and the backlit type display panel 4. The reflective narrow-angle diffuser 23 deploys the single-curved concave surface to converge the light L for the first time and diffuse each point of the light L with a narrow diffusion angle, and reflect the light L to the concave reflector 33, the concave reflector 33 deploying the single-curved concave surface at different axes to converge the light L for the second time, so that the reflected and diffused uniform directional light beam D penetrating the backlit type display panel 4, and then projecting to the eye box E in high directivity.

In some embodiments, axes of the concave surface of the reflective narrow-angle diffuser 23 correspond to the vertical direction, the horizontal direction, the 45-degree oblique direction or any directions of the displayed image I.

In some embodiments, the curvature of the reflective narrow-angle diffuser is further reduced, for example, a single-curved slightly concave reflective narrow-angle diffuser is deployed to simplify the production process and reduce the cost. In order to converge the reflected and diffused light, the single-curved slightly concave reflective narrow-angle diffuser is assisted with a dual-curved concave reflector to compensate for the insufficient and lack axial concave curvature of the reflective narrow-angle diffuser, hereby the projected light being converged to the same area and is sufficient to cover the preset projection area.

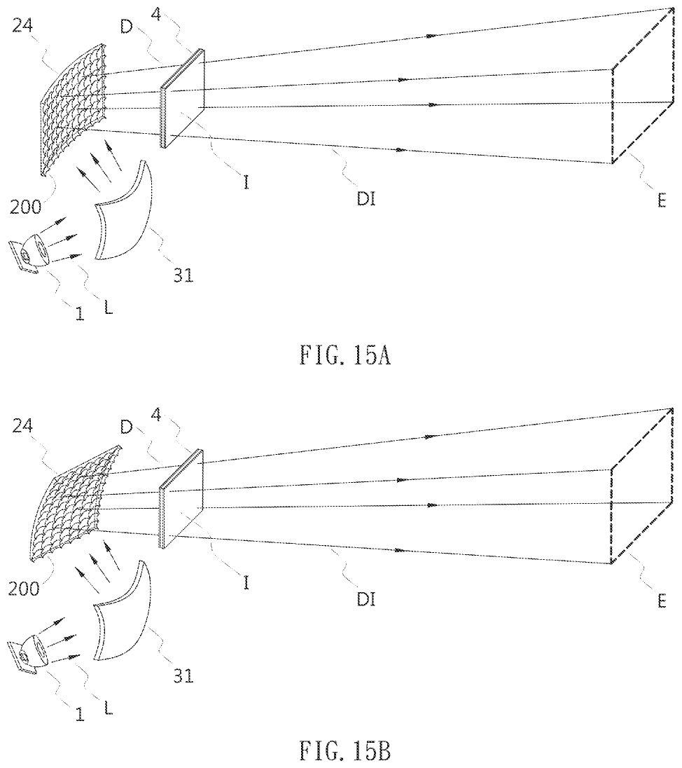

Please refer to FIG. 15A, FIG. 15B, FIG. 16A and FIG. 16B, the present disclosure provides an embodiment of a directivity backlight display device with reflector curvature assisted diffuser comprising a light source module 1 projecting a light L, a reflective narrow-angle diffuser 24, a concave reflector 31 and a backlit type display panel 4.

A reflective narrow-angle diffuser 24 extends along one axis to form a single-curved concave surface with a low curvature (i.e., a single-curved slightly concave surface) served as a reflecting surface. The reflecting surface is provided with a plurality of micro curved mirrors 200 laid out in an array to reflect and diffuse the light L.

A concave reflector 31 has two axes cross each other perpendicularly. The concave reflector 31 extends along the two axes to form a dual-curved concave surface. One of the two axes of the concave surface corresponds to one of the two axes of the slightly concave surface of the reflective narrow-angle diffuser 24. The concave reflector 31 compensates for the insufficient and lack of axial direction curvature of the slightly concave surface of the reflective narrow-angle diffuser 24, so the light L is reflected and diffused by the reflective narrow-angle diffuser 24 and the concave reflector 31 to provide a uniform directional light beam D.

A backlit type display panel 4 displays an image I, the uniform directional light beam D penetrates the backlit type display panel 4 and then becomes a directional image light beam DI, and the directional image light beam DI projects to a projection area (i.e., an eye box E of an observer).

Please refer to FIG. 15A and FIG. 15B, the concave reflector 31 is positioned on an optical path between the light source module 1 and the reflective narrow-angle diffuser 24. The concave reflector 31 deploys the dual-curved concave surface to converge the light L for the first time and reflect the light L to the reflective narrow-angle diffuser 24, the reflective narrow-angle diffuser 24 deploying the single-curved slightly concave surface to converge the light L for the second time and diffuse each point of light L with a narrow diffusion angle, so that the reflected and diffused uniform directional light beam D penetrating the backlit type display panel 4, and then projecting to the eye box E in high directivity.

Please refer to FIG. 16A and FIG. 16B, the concave reflector 31 is positioned on an optical path between the reflective narrow-angle diffuser 24 and the backlit type display panel 4. The reflective narrow-angle diffuser 24 deploys the single-curved slightly concave surface to converge the light L for the first time and diffuse each point of light L with a narrow diffusion angle, and reflect the light L to the concave reflector 31, the concave reflector 31 deploying the dual-curved concave surface to converge the light L for the second time, so that the reflected and diffused uniform directional light beam D penetrating the backlit type display panel 4, and then projecting to the eye box E in high directivity.

In some embodiments, axes of the slightly concave surface of the reflective narrow-angle diffuser 24 correspond to the vertical direction, the horizontal direction, the 45-degree oblique direction or any directions to the displayed image I.

In some embodiments, a flat-surfaced reflective narrow-angle diffuser is deployed, so that there is no need for bonding the curved surfaces of the diffuser, hereby raising the production yield and lowering the cost.

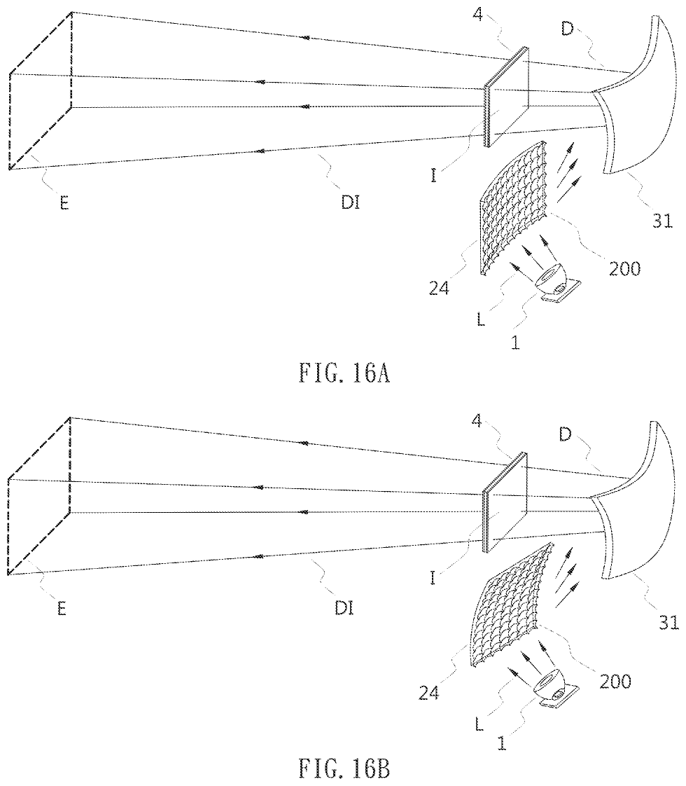

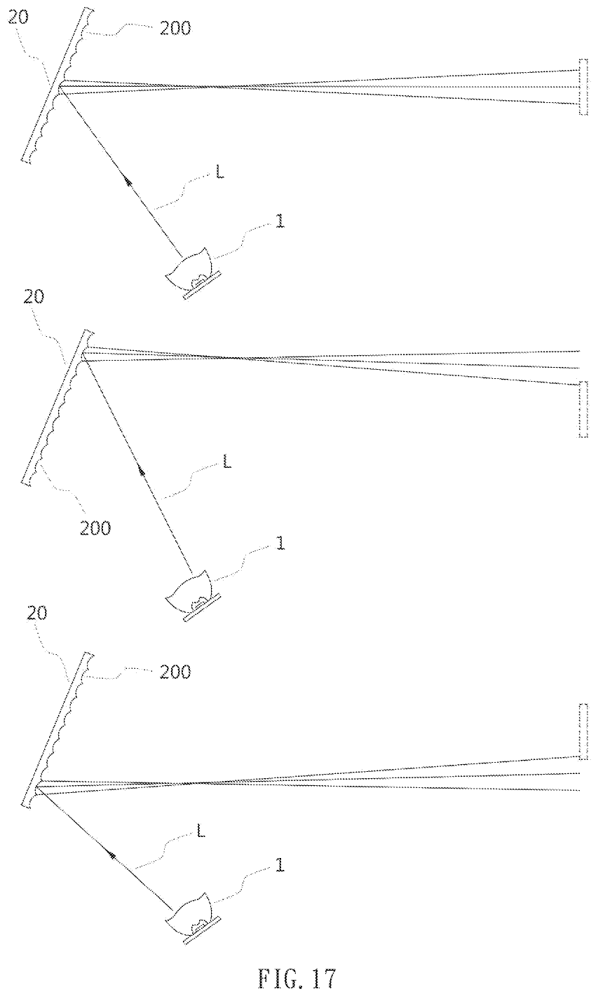

Please refer to FIG. 17, the reflective narrow-angle diffuser 20 comprises a flat surface served as a reflecting surface (the curvature of the flat surface is zero), the reflected and diffused light unable to cover the preset projection area and the light at various positions of the diffuser is unable to be projected to the same area.

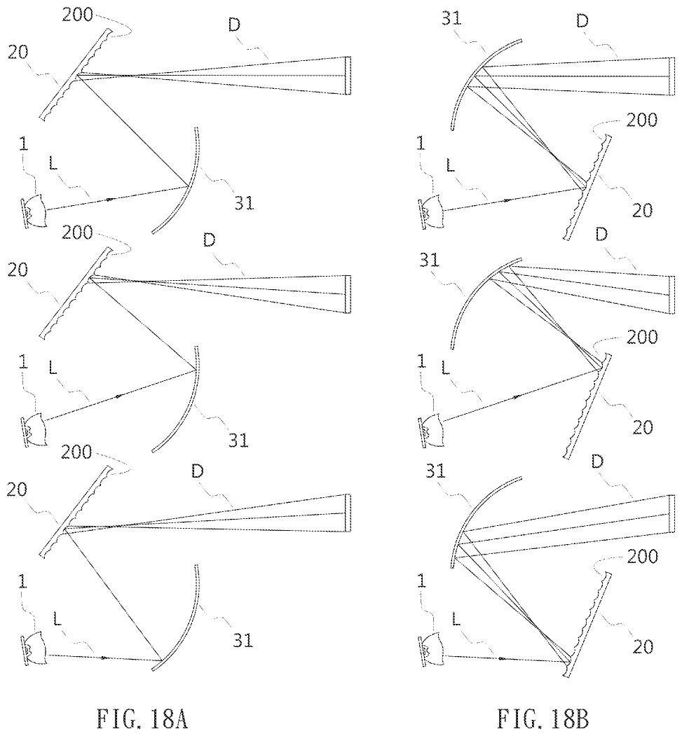

In order to converge the reflected and diffused light L, as shown in FIG. 18A, a dual-curved concave reflector 31 is positioned between the light source 1 and flat-surfaced the reflective narrow-angle diffuser 20, or as shown FIG. 18B, a dual-curved concave reflector 31 is included after the flat-surfaced reflective narrow-angle diffuser 20 to compensate for the lack of axial direction concave surface curvature, hereby the projected light rays are all converged to the same area, which is sufficient to cover the preset projection area.

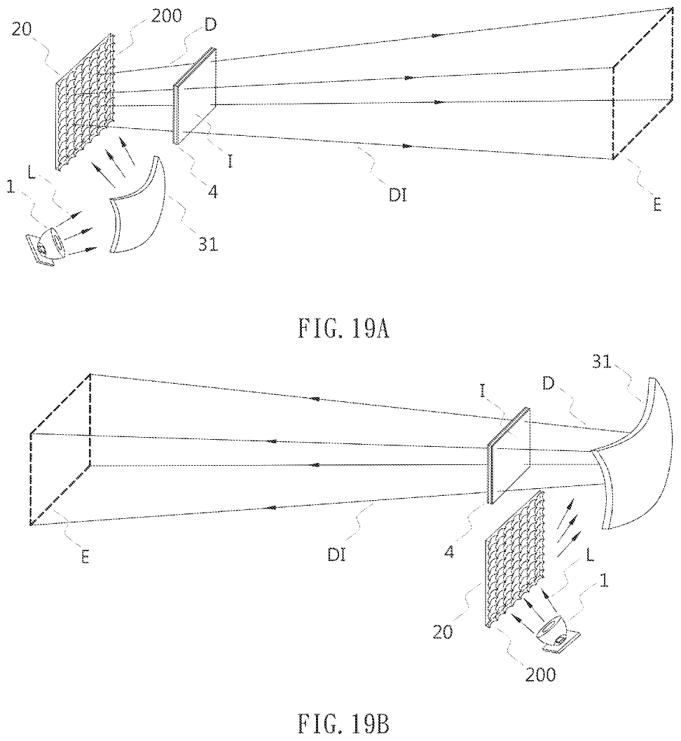

Please refer to FIG. 19A and FIG. 19B, the present disclosure provides an embodiment of a directivity backlight display device with reflector curvature assisted diffuser comprising a light source module 1 projecting a light L, a reflective narrow-angle diffuser 20, a concave reflector 31 and a backlit type display panel 4.

A reflective narrow-angle diffuser 20 comprises a flat surface served as a reflecting surface. The reflecting surface is provided with a plurality of micro curved mirrors 200 laid out in an array to reflect and diffuse the light L.

A concave reflector 31 has two axes cross each other perpendicularly. The concave reflector 31 extends along the two axes to form a dual-curved concave surface to compensate for the lack of curvature of the curved surface of the reflective narrow-angle diffuser 20 in the two axes. The light L is reflected and diffused by the reflective narrow-angle diffuser 20 and the concave reflector 31 to provide a uniform directional light beam D.

A backlit type display panel 4 displays an image I, the uniform directional light beam D penetrates the backlit type display panel 4 and then becomes a directional image light beam DI, and the directional image light beam DI projects to a projection area (i.e., an eye box E of an observer).

Please refer to FIG. 19A, the concave reflector 31 is positioned on an optical path between the light source module 1 and the reflective narrow-angle diffuser 20. The concave reflector 31 deploys the dual-curved concave surface to converge the light L and then reflect the light L to the reflective narrow-angle diffuser 20, the reflective narrow-angle diffuser 20 diffusing each point of light L with a narrow diffusion angle, so that the reflected and diffused uniform directional light beam D penetrating the backlit type display panel 4, and then projecting to the eye box E in high directivity.

Please refer to FIG. 19B, the concave reflector 31 is positioned on an optical path between the reflective narrow-angle diffuser 20 and the backlit type display panel 4. The reflective narrow-angle diffuser 20 diffuses each point of light L with a narrow diffusion angle, and reflects the light L to the concave reflector 31, the concave reflector 31 deploying the dual-curved concave surface to converge the light L, so that the reflected and diffused uniform directional light beam D penetrating the backlit type display panel 4, and then projecting to the eye box E in high directivity.

In some embodiments, both axes of the concave reflector 31 correspond to the vertical direction and the horizontal direction to the displayed image I respectively.

In some embodiments, curvatures along both axes of the concave surface of the concave reflector 31 are identical or non-identical.

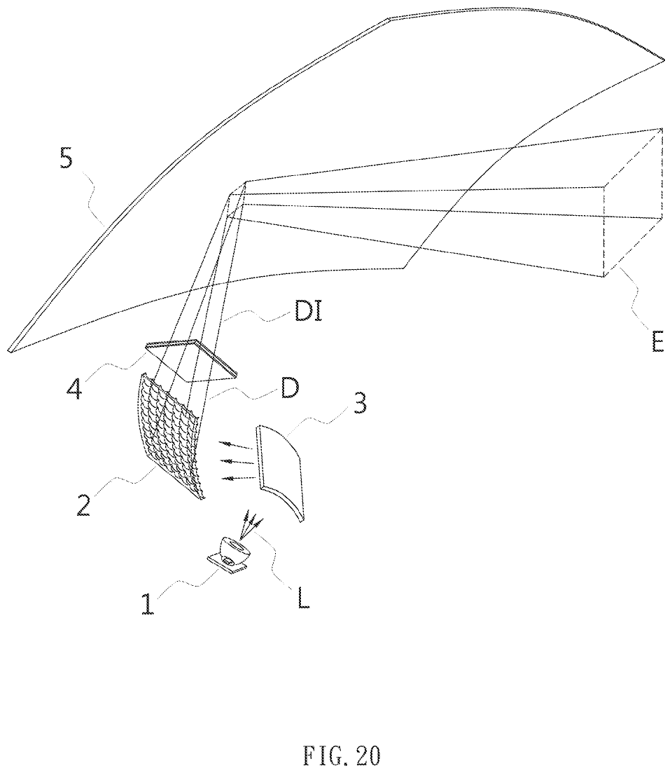

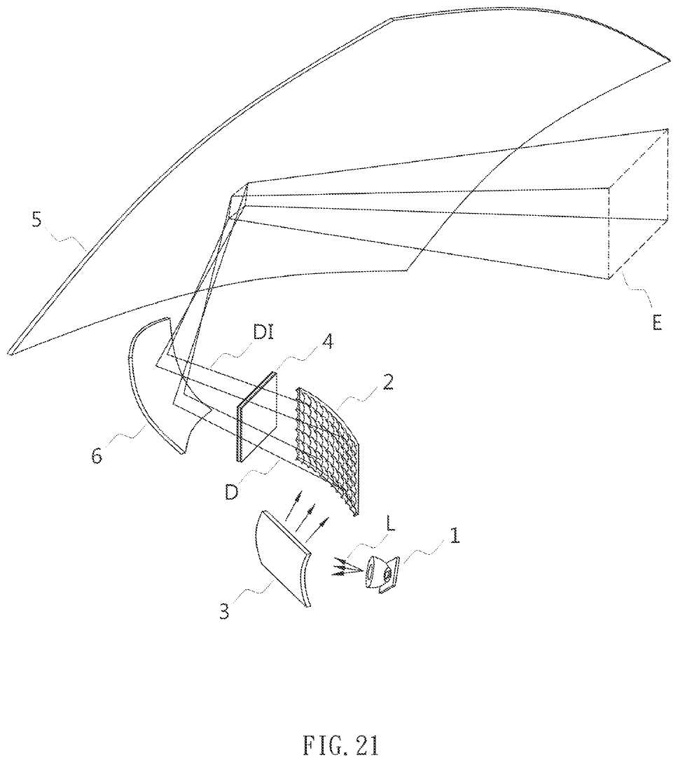

Please refer to FIG. 20, according to some embodiments of the present disclosure, a windshield 5 is included, enabling the observer to observe the projected image and scenery outside the windshield 5. A light source module 1 projects a light L. The light L is reflected and diffused by a concave reflector 3 and a reflective narrow-angle diffuser 2 to provide a uniform directional light beam D, the uniform directional light beam D penetrating the backlit type display panel 4 to provide a directional image light beam DI, the directional image light beam DI projecting to the windshield 5, the windshield 5 reflecting part of the directional image light beam DI to an eye box E.

Please refer to FIG. 21, according to some embodiments of the present disclosure, a concave mirror 6 is included to magnify the image and lengthen a virtual image distance. A light source module 1 projects a light L. The light is reflected and diffused by the concave reflector 3 and the reflective narrow-angle diffuser 2 to provide a uniform directional light beam D, the uniform directional light beam D penetrating the backlit type display panel 4 to provide a directional image light beam DI, the directional image light beam DI being projected to the concave mirror 6, the concave mirror 6 reflecting the directional image light beam DI to the windshield 5, the windshield 5 reflecting part of the directional image light beam DI to the eye box E.

What is claimed is:

1. A directivity backlight display device with reflector curvature assisted diffuser, comprising:
a light source module, projecting a light;
a reflective narrow-angle diffuser, comprising a concave surface or a flat surface served as a reflecting surface;
wherein the reflecting surface is provided with a plurality of micro curved mirrors laid out in an array,
wherein the reflective narrow-angle diffuser is arranged to reflect the light and uniformly diffuse the light with a narrow diffusion angle;
a concave reflector, comprising a concave surface served as a reflecting surface, wherein the concave surface compensates the insufficient concave curvature of the reflective narrow-angle diffuser,
wherein the reflective narrow-angle diffuser and the concave reflector reflect the light to provide a uniform directional light beam; and
a backlit type display panel, displaying an image;
wherein the uniform directional light beam penetrates the backlit type display panel to provide a directional image light beam;
wherein the directional image light beam projects to a projection area.

2. The directivity backlight display device with reflector curvature assisted diffuser of claim 1, wherein the reflective narrow-angle diffuser has two axes cross each other perpendicularly, wherein the reflecting surface of the reflective narrow-angle diffuser extends along the two axes of the reflective narrow-angle diffuser to form the concave surface of the reflective narrow-angle diffuser, wherein the concave reflector has two axes cross each other perpendicularly, the reflecting surface of the concave reflector extends along the two axes of the concave reflector to form the concave surface of the concave reflector, wherein the two axes of the reflective narrow-angle diffuser correspond to the two axes of the concave reflector.

3. The directivity backlight display device with reflector curvature assisted diffuser of claim 1, wherein the reflecting surface of the reflective narrow-angle diffuser extends along one axis of reflective narrow-angle diffuser to form the concave surface of the reflective narrow-angle diffuser, wherein the reflecting surface of the concave reflector extends along the other axis of the concave reflector to form the concave surface of the concave reflector, wherein the axial direction of the concave reflector is perpendicular to the other axis of the reflective narrow-angle diffuser.

4. The directivity backlight display device with reflector curvature assisted diffuser of claim 1, wherein the reflecting surface of the reflective narrow-angle diffuser extends along one axis of reflective narrow-angle diffuser to form the concave surface of the reflective narrow-angle diffuser, wherein the concave reflector has two axes cross each other perpendicularly, wherein the reflecting surface of the concave reflector extends along the two axes of the concave reflector to form the concave surface of the concave reflector,
wherein one of the two axes of the concave reflector is parallel to the axis of the reflective narrow-angle diffuser.

5. The directivity backlight display device with reflector curvature assisted diffuser of claim 1, the reflecting surface of the reflective narrow-angle diffuser is the flat surface, wherein the concave reflector has two axes cross each other perpendicularly, the reflecting surface of the concave reflector extends along the two axes of the concave reflector to form the concave surface of the concave reflector.

6. The directivity backlight display device with reflector curvature assisted diffuser of claim 2, wherein the concave reflector is positioned on an optical path between the light source module and the reflective narrow-angle diffuser.

7. The directivity backlight display device with reflector curvature assisted diffuser of claim 3, wherein the concave reflector is positioned on an optical path between the light source module and the reflective narrow-angle diffuser.

8. The directivity backlight display device with reflector curvature assisted diffuser of claim 4, wherein the concave reflector is positioned on an optical path between the light source module and the reflective narrow-angle diffuser.

9. The directivity backlight display device with reflector curvature assisted diffuser of claim 5, wherein the concave reflector is positioned on an optical path between the light source module and the reflective narrow-angle diffuser.

10. The directivity backlight display device with reflector curvature assisted diffuser of claim 2, wherein the concave reflector is positioned on an optical path between the reflective narrow-angle diffuser and the backlit type display panel.

11. The directivity backlight display device with reflector curvature assisted diffuser of claim 3, wherein the concave reflector is positioned on an optical path between the reflective narrow-angle diffuser and the backlit type display panel.

12. The directivity backlight display device with reflector curvature assisted diffuser of claim 4, wherein the concave reflector is positioned on an optical path between the reflective narrow-angle diffuser and the backlit type display panel.

13. The directivity backlight display device with reflector curvature assisted diffuser of claim 5, wherein the concave reflector is positioned on an optical path between the reflective narrow-angle diffuser and the backlit type display panel.

14. The directivity backlight display device with reflector curvature assisted diffuser of claim 1, further comprising a windshield, wherein the directional image light beam projects to the windshield, wherein the windshield reflects part of the directional image light beam to the projection area.

15. The directivity backlight display device with reflector curvature assisted diffuser of claim 14, further comprising a concave mirror, wherein the concave mirror reflects the directional image light beam and then projects the directional image light beam to the windshield, wherein the windshield reflects part of the directional image light beam to the projection area.
